(19) United States
(12) Patent Application Publication
(10) Pub. No.: US 2008/0100847 A1
(43) Pub. Date: May 1, 2008

(54) Heterodyne Photonic Dispersion and Loss Analyzer

(76) Inventor: Bogdan Szafraniec, Sunnyvale, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/553,422

(22) Filed: Oct. 26, 2006

(51) Int. Cl. G01B 9/02

(52) U.S. Cl. 356/491; 356/477

(57) ABSTRACT

A method and apparatus for determining the optical parameters of a device under test (DUT) is disclosed. A first portion of an optical signal is modulated to generate a first modulated signal. The first modulated signal is applied to the DUT to output a test signal. A second portion of the optical signal is modulated to create a reference signal. The test signal and reference signal are optically combined into a combined signal. An electrical signal generated from the combined signal is processed to determine at least one optical parameter of the DUT. Processing the electrical signal includes demodulating the electrical signal.

### CROSS-REFERENCE TO RELATED APPLICATIONS

This application is related by subject matter to U.S. application for patent Ser. No. 11/112,457, (Attorney Docket #10040927-1), entitled “Elementary Matrix Based Optical Signal/Network Analyzer,” which was filed on Apr. 22, 2005.

### BACKGROUND OF THE INVENTION

Determining the optical characteristics of optical components and networks is an important element to the successful design and operation of optical communications networks. Important characteristics of an optical component or network include (but are not limited to) group delay, differential group delay (DGD), power, and polarization dependent loss (PDL).

The group delay is a measure of the dispersion of an optical signal traveling through a device under test (DUT). The differential group delay is a measure of dispersion with respect to the polarization of the optical signal traveling through the DUT. Power is a measure of the intensity of the optical signal after traveling through the DUT. PDL is a measure of the polarization state dependent attenuation of the optical signal.

A traditional way of measuring the group delay and the differential group delay is the phase shift method. In the phase shift method, an intensity-modulated input optical signal is transmitted through a device under test (DUT). The optical signal at the output of the DUT is then directly detected. For example, the phase shift in the intensity modulation between the input and output optical signals provides a measure of the group delay. In the case of the differential group delay, multiple measurements need to be performed for different polarization states of the input optical signal. The phase shift method also allows a measurement of power and PDL from the strength of the received signals.

The strength of the phase shift method is its immunity to optical phase noise and vibration. However, it requires direct detection of the optical signal from the DUT, which yields electrical signals proportional to the intensity of the received optical signal. Thus, the dynamic range of this method is relatively limited.

A traditional interferometric heterodyne optical system overcomes the limited dynamic range of the phase shift method. In a traditional heterodyne optical system, a signal from an optical local oscillator is combined with an optical signal from the DUT. As a result, the detected optical signal generates electrical signals that are proportional to \sqrt{IₛI_{LO}}, where I_{LO} denotes the intensity of the optical local oscillator signal, and Iₛ denotes the intensity of the optical signal transmitted through the DUT. In this manner, even a weak optical signal from the DUT can be amplified by mixing with a strong optical local oscillator signal.

However, the previous interferometric heterodyne method needed to measure the amplitude and phase of the generated electrical signals to determine a DUT's group delay and differential group delay characteristics. This method is reliable so long as those quantities of amplitude and phase are measurable. Unfortunately, DUTs with long optical signal paths (e.g. optical fiber spools) produce electrical output signals with high frequencies and difficult-to-measure phases due to the local oscillator sweep and/or the local oscillator optical phase noise.

### SUMMARY OF THE INVENTION

A method and apparatus for determining the optical parameters of a device under test (DUT) is disclosed. A first portion of an optical signal is modulated to generate a first modulated signal. The first modulated signal is applied to the DUT to output a test signal. A second portion of the optical signal is modulated to create a reference signal. The test signal and reference signal are optically combined into a combined signal. An electrical signal generated from the combined signal is processed to determine at least one optical parameter of the DUT. Processing the electrical signal includes demodulating the electrical signal.

### BRIEF DESCRIPTION OF THE DRAWINGS

FIG. 1 depicts a system for determining optical characteristics of a DUT, according to embodiments of the present invention.

FIG. 2 is a block diagram view of the processing unit, according to embodiments of the present invention.

FIG. 3 shows exemplary signals from within the processing unit.

### DETAILED DESCRIPTION

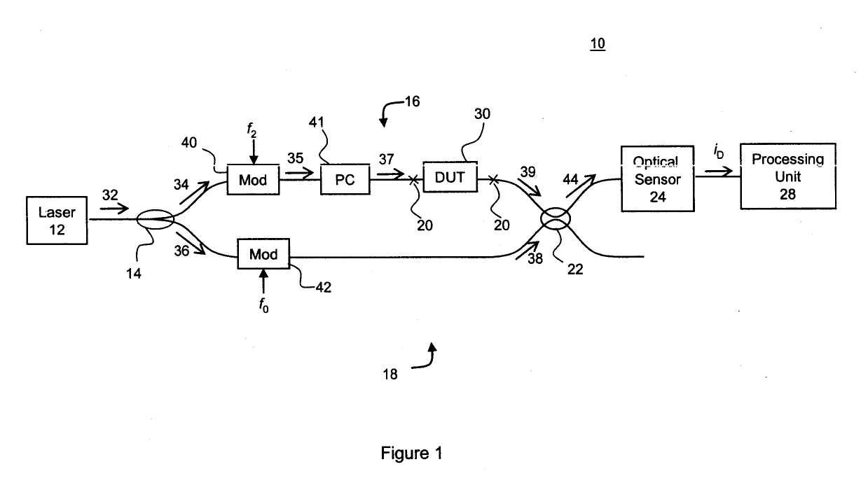

FIG. 1 depicts a system 10 for determining optical characteristics of a DUT 30, in accordance with embodiments of the present invention. The system includes a laser source 12, an optical splitter 14, a test branch 16, a reference branch 18, a DUT interface 20, a coupler 22, an optical sensor 24, and a processing unit 28. For description purposes, the system is connected to a DUT 30 although the DUT is not necessarily a part of the system.

Referring to FIG. 1, the laser source 12 generates an optical signal 32. In one embodiment, the laser source 12 is a tunable, highly coherent laser that may be continuously swept. During DUT characterization, the optical signal 32 is typically swept across a range of wavelengths (frequencies) in order to characterize the DUT over the range of wavelengths (frequencies). The sweep rate of the laser source 12 is represented by γ.

The laser source 12 is in optical communication with the optical splitter 14, which splits the optical signal 32 into a test signal 34 that travels along the test branch 16, and a reference signal 36 that travels along the reference branch 18. The reference signal 36 may also be referred to as a local oscillator. In one embodiment, the test and reference branches 16 and 18 are two branches of an interferometer. The test and reference signals 34 and 36 are generated when the optical signal 33 is split by the optical splitter 14.

The test branch 16 includes a modulator 40, a polarization controller 41 and the DUT interface 20. The DUT interface 20 optically connects the DUT 30 to the system 10. In the configuration of FIG. 1, the DUT interface is intended to include any optical system or mechanism that enables the DUT to be optically connected between the modulator 40 and the coupler 22. The DUT 30 may be any component having optical characteristics that need to be determined, e.g.: a fiber, a filter, a multiplexer, a demultiplexer, a circulator, tissue samples, etc. The DUT may also be an optical network that is made up of multiple optical components.

The test branch 16 optically connects the optical splitter 14 to the coupler 22 such that the test signal 34 propagates from the optical splitter 14, through the modulator 40, the polarization controller 41, and the DUT 30, to the coupler 22.

The modulator 40 modulates the test signal 34 at a frequency f₂ and generates a modulated test signal 35 having optical sidebands created at the frequencies v_{c}±nf₂, where vₒ is the optical frequency and n is the sideband number. The modulator 40 can be any phase, intensity, or polarization modulator. A polarization modulator modulation properties are polarization state dependent.

The polarization controller 41 controls the polarization state of the optical sidebands in the modulated test signal 35, generating test signal 37. The functions of the modulator 40 and the polarization controller 41 may be combined into one component. In one embodiment, the functions of the modulator 40 and the polarization controller 41 are performed by a lithium niobate polarization (LiNbO₃) phase modulator whose electro-optic coefficients are different for the TE and TM propagation modes.

At this point, it may be helpful to the reader's understanding to see a mathematical representation of the electric field of the test signal 37, prior to the test signal 37 passing through the DUT 30. For the sake of simplicity, only the first order sidebands of the test signal 37 (n=1) will be considered. However, it should be noted that other sidebands in the test signal 37 may also be used in characterizing the DUT 30. In Jones vector notation, the electric field that describes these first order sidebands is:

E₁=exp(j2πvₒt)(exp(−j2πf₂t)Eₒ+exp(j2πf₂t)E₀) (1)

where the Jones vector

$${E}_{0} = ( \begin{matrix}cos ( α ) \\ sin ( α ) exp ( j ϕ )\end{matrix} )$$

and the angles α and φ uniquely describe on the Poincare sphere the polarization state created by the polarization controller 41.

The test signal 37 then passes through the DUT 30, generating the DUT test signal 39. The positive and negative first order sidebands of the test signal 37 are perturbed in an opposite way by the DUT 30, resulting in a phase shift between the positive and negative sidebands. This behavior is described in more detail in U.S. application Ser. No. 11/112,457 which is referenced above. The electric field of the DUT test signal 39 can be described using Jones vector notation as

Eₜₑₛₜ=exp(j2πvₒt)(exp(−j2πf₂t)(1−2πf₂N)E₀+exp(j2πf₂t)(1+2πf₂N)E₀) (2)

where N is an elementary matrix describing the DUT 30 and comprising elementary perturbations as described in the Appendix. The modulation frequency f₂ for the modulator 40 is selected so that the system 10 is able to detect the resulting phase shift between the positive and negative sidebands. The larger the modulation frequency f₂, the larger the phase shifts 2πf₂N as seen in equation (2). In one embodiment, the frequency f₂ is between hundreds of MHz to a few GHz.

The reference branch 18 of the system 10 includes a modulator 42. The reference branch 18 optically connects the optical splitter 14 to the coupler 22 such that the reference signal 36 can propagate from the optical splitter 14 through the modulator 42 to the coupler 22. The modulator 42 modulates the reference signal 36 at a frequency f₀ and generates a modulated reference signal 38. The modulator 42 is a polarization modulator whose modulation properties are polarization state dependent. The modulation frequency f₀ is typically much smaller than f₂, typically in the tens or hundreds of kHz. This is to avoid interactions between the optical sidebands in test and reference signals once they are recombined at the coupler 22. In one embodiment, the modulator 42 is a LiNbO₃ polarization modulator.

In one embodiment, the modulator 42 also depolarizes the reference signal 36. Depolarized light (sometimes referred to as “pseudo-depolarized light”) refers to a scenario in which, if all the polarization states of the depolarized light were to be mapped onto a Poincare sphere, they would form a trajectory on the surface of the Poincare sphere, and the average of those polarization states would be the center of the Poincare sphere. In mathematical terms, for a sinusoidal modulation and a simple birefringence modulator, the light is depolarized when the 0^{th} Bessel function of the phase difference modulation is 0, i.e.: J₀(a₀−b₀)=0, where a₀ and b₀ denote the modulation depths of the orthogonal linear polarization modes (TE and TM). The significance of depolarizing the reference signal 36 shall be discussed in more detail below.

The electric field of the modulated reference signal 38 can be described in Jones vector notation as follows:

$${E}_{ref} = exp ( j 2 π {v}_{o} t - j 2 πγτ t ) ( \begin{matrix}exp ( {ja}_{o} cos ( 2 π {f}_{o} t ) ) \\ exp ( {jb}_{o} cos ( 2 π {f}_{o} t ) )\end{matrix} ) ( \begin{matrix}1 \\ exp ( j ξ )\end{matrix} ) \qquad ( 3 )$$

where a₀ and b₀ are modulation depths, γ is the laser source sweep rate, ξ is the polarization state parameter, and τ is the interferometer free spectral range (FSR) or delay. The quantity γτ represents the frequency shift between the test and reference branches 16 and 18 due to the sweep of the laser source 12.

The coupler 22 optically combines the DUT test signal 39 and modulated reference signal 38 into a combined signal 44 and outputs at least a portion of the combined signal 44 to the optical sensor 24. The coupler 22 is typically a fiber optic coupler, such as an SM coupler.

The optical sensor 24 is a square-law detector, and includes at least one photodetector (such as a photodiode) that generates electrical signals in response to the received optical signal. Since it is a square-law detector, the optical sensor 24 produces current i_{D} proportional to the intensity of the combined optical waves:

i_{D}=|Eₜₑₛₜ+E_{ref}|² (4)

The signal i_{D} is passed to the processing unit 28 for use in characterizing the DUT 30. In particular, the characteristics that the processing unit 28 can determine include (but are not limited to): the group delay, differential group delay, loss, and PDL of the DUT 30.

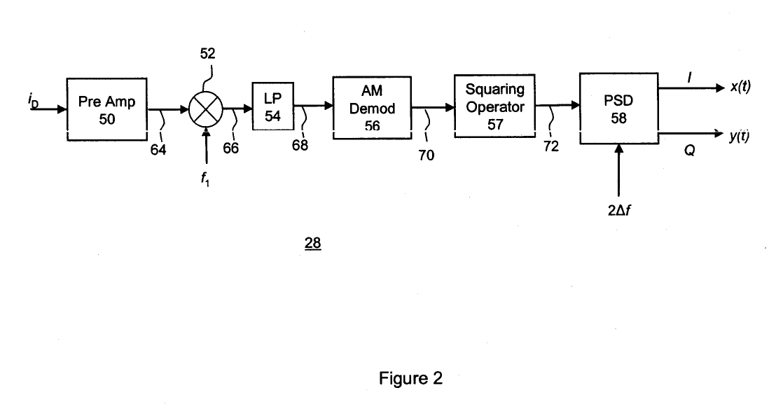

FIG. 2 is a block diagram view of the processing unit 28, according to embodiments of the present invention. The processing unit 28 includes a pre-amplifier 50, a mixer 52, a low-pass (LP) filter 54, an amplitude modulation (AM) demodulator 56, a squaring operator 57, and a phase sensitive detector (PSD) 58.

The pre-amplifier 50 amplifies the signal i_{D} to the desired level and generates an amplified signal 64. Next, the amplified signal 64 is mixed at a mixer 52 with a signal at the frequency f₁, producing a mixed signal 66. The mixed signal 66 is sent through a low-pass filter 54, producing a filtered signal 68 that contains the frequency difference Δf=f₂−f₁. The frequencies f₂ and f₁ are selected such that the frequency difference Δf=f₂−f₁ and γτ±Δf are well within the pass-band of the low-pass filter 54. The filtered signal 68 is then passed through an AM demodulator 56, producing a demodulated signal 70 that has all high frequency carrier phase information discarded.

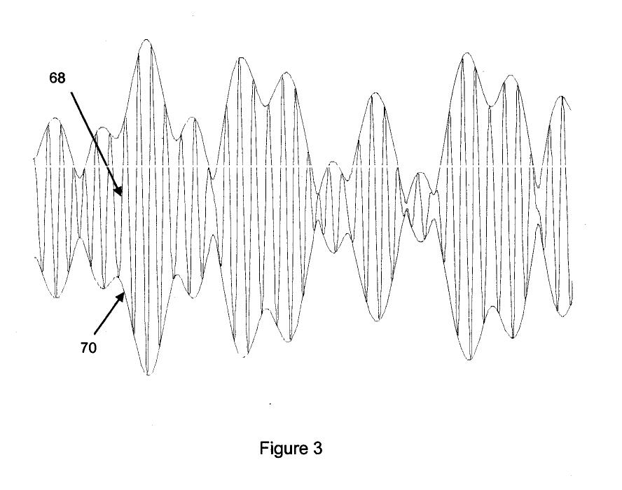

In the past, the AM demodulation was not performed and the amplitude and phase of the filtered signal 68 was measured directly. As described above, direct measurement works for short DUTs. However, the high-frequency signals and phase noise produced by a long DUT made it difficult to measure those quantities directly. FIG. 3 shows an exemplary filtered signal 68 and a demodulated signal 70. As can be seen in FIG. 3, when the frequency and phase noise of the filtered signal 68 get too high (as is the case with long DUTs), it becomes impossible to measure frequency and/or phase directly.

The effect of the AM demodulator 56 is to create a demodulated signal 70 that is essentially just the signal envelope of the filtered signal 68. The desired characterization information about the DUT 30 can still be extracted from the signal envelope of the filtered signal 68. The signal envelope is at a frequency Δf=f₂−f₁. Thus, even when filtered signal 68 is high-frequency or noisy, it can still be analyzed by the processing unit 28 to characterize the DUT 30.

Referring back to FIG. 2, the signal 70 is squared by a squaring operator 57 to produce a squared signal 72. After squaring, the desired characterization information in the squared signal 72 is at a frequency 2Δf. The PSD 58 selects a 2Δf component of the squared signal 72 by mixing it with the reference signal at that frequency and low-pass filtering. The frequency 2Δf is used to select the first sidebands of the optical signal; however, other frequencies could be used if other sidebands were to be selected. For example, the second sidebands can be selected by using the frequency 2 f₁ instead f₁ in the mixer 52. Then, the envelope of the demodulated signal 70 would contain the frequency 2Δf. The phase shift detection would then be performed, after squaring, at the frequency 4Δf.

The PSD 58 generates the in-phase (I) and phase-quadrature (Q) components of the squared signal 72. The I component of the demodulated signal 70 is equal to x(t). The Q component of the squared signal 72 is equal to y(t). By following the procedure described above the closed form solutions can be found for all the signals described above. The details of the derivation are omitted as they will be apparent to one of ordinary skill in the art. The equations for x(t) and y(t) are shown below:

$$\begin{matrix}x ( t ) = i + u {J}_{0} ( {a}_{0} - {b}_{0} ) cos ( ξ ) + {vJ}_{0} ( {a}_{0} - {b}_{0} ) sin ( ξ ) \\ and & ( 5 ) \\ \begin{matrix}y ( t ) / 2 = ( i + {uJ}_{0} ( {a}_{0} - {b}_{0} ) cos ( ξ ) + {vJ}_{0} ( {a}_{0} - {b}_{0} ) sin ( ξ ) ) {p}_{0} + \\ ( - q ) {p}_{1} + ( - u - {iJ}_{0} ( {a}_{0} - {b}_{0} ) cos ( ξ ) {p}_{2} + \\ ( v + {iJ}_{0} ( {a}_{0} - {b}_{0} ) sin ( ξ ) ) {p}_{3} + 0 \cdot {p}_{4} + \\ ( {vJ}_{0} ( {a}_{0} - {b}_{0} ) cos ( ξ ) - {uJ}_{0} ( {a}_{0} - {b}_{0} ) sin ( ξ ) ) {p}_{5} + \\ ( {qJ}_{0} ( {a}_{0} - {b}_{0} ) sin ( ξ ) ) {p}_{6} + ( {qJ}_{0} ( {a}_{0} - {b}_{0} ) cos ( ξ ) ) {p}_{7}\end{matrix} & ( 6 )\end{matrix}$$

where ξ describes the polarization state parameter of the modulated reference signal 38 and i, q, u and v are elements of the Stokes vector describing the polarization state of the test signal 37.

In one embodiment, the reference signal 36 is depolarized by the modulator 42 to create a depolarized modulated reference signal 38. In general, the depolarization of the reference signal 36 is not necessary. However, it simplifies the process of characterizing the DUT 30 because when the modulated reference signal 38 is depolarized, the 0^{th} order Bessel function J₀ of the series expansion of the in-phase signal x(t) and the quadrature signal y(t) is equal to zero, i.e.: J₀(a₀−b₀)=0.

Thus, when the modulated reference signal 38 is depolarized, the in-phase component of the phase sensitive detection at the frequency 2Δf is reduced to:

x(t)=i (7)

The quadrature component of the phase sensitive detection is reduced to:

y(t)/2=ip₀−qp₁−up₂+vp₃ (8)

where pᵢ are the sought elementary parameters, and i, q, u and v are elements of the Stokes vector describing the polarization state of the test signal 37. The intensity of the optical wave, i, is determined from the in-phase demodulated signal in equation (7). The remaining Stokes vector parameters are related to the earlier introduced angles α and φ by the following equation:

$$( \begin{matrix}i \\ q \\ u \\ v\end{matrix} ) = i ( \begin{matrix}1 \\ cos ( 2 α ) \\ sin ( 2 α ) cos ( ϕ ) \\ sin ( 2 α ) sin ( ϕ )\end{matrix} ) \qquad ( 9 )$$

Therefore, by making 4 measurements for four different polarization states (iᵢ,qᵢ,uᵢ,vᵢ), where the subscript i denotes the number of polarization state, the elementary parameters p₀, p₁, p₂, and p₃ can be determined from a set of four equations each having a form of equation (8). The DUT group delay (GD) is directly determined by p₀:

GD=p₀ (10)

The differential group delay (DGD) of the DUT is determined as follows:

DGD=\sqrt{p₁²+p₂²+p₃²} (11)

The loss and PDL of the DUT can be determined from the in-phase signal x(t). The process for determining loss and PDL are obvious to one of ordinary skill in the art, and therefore will not be discussed in further detail here.

### Appendix

The elementary perturbations represented by N are described by the following matrices.

The group delay matrix can be represented as:

$${N}_{0} = {p}_{0} ( \begin{matrix}- j & 0 \\ 0 & - j\end{matrix} ) , \qquad ( 12 )$$

where p₀ represents the group delay.

The 0° linear birefringence matrix can be represented as:

$${N}_{1} = {p}_{1} ( \begin{matrix}j & 0 \\ 0 & - j\end{matrix} ) , \qquad ( 13 )$$

where pᵢ represents the 0° component of the differential group delay.

The 45° linear birefringence matrix can be represented as:

$${N}_{2} = {p}_{2} ( \begin{matrix}0 & j \\ j & 0\end{matrix} ) , \qquad ( 14 )$$

where p₂ represents the 45° component of the differential group delay.

The circular birefringence matrix can be represented as:

$${N}_{3} = {p}_{3} ( \begin{matrix}0 & - 1 \\ 1 & 0\end{matrix} ) , \qquad ( 15 )$$

where p₃ represents the circular component of the differential group delay.

The differential absorption matrix can be represented as:

$${N}_{4} = {p}_{4} ( \begin{matrix}- 1 & 0 \\ 0 & - 1\end{matrix} ) , \qquad ( 16 )$$

where p₄ represents absorption per unit frequency (the frequency derivative of the absorption).

The differential 0° linear dichroism matrix can be represented as:

$${N}_{5} = {p}_{5} ( \begin{matrix}1 & 0 \\ 0 & - 1\end{matrix} ) , \qquad ( 17 )$$

where p₅ represents the 0° component of the polarization dependent loss frequency derivative.

The differential 45° linear dichroism matrix can be represented as:

$${N}_{6} = {p}_{6} ( \begin{matrix}0 & 1 \\ 1 & 0\end{matrix} ) , \qquad ( 18 )$$

where p₆ represents the 45° component of the polarization dependent loss frequency derivative.

The differential circular dichroism matrix can be represented as:

$${N}_{7} = {p}_{7} ( \begin{matrix}0 & - j \\ j & 0\end{matrix} ) , \qquad ( 19 )$$

where p₇ represents the circular component of the polarization dependent loss frequency derivative.

The above definitions differ slightly from those presented by Jones. Instead of thin slices of material as presented by Jones, small increments of optical frequency are considered a preferred embodiment of the present invention. Since the net perturbation can be induced by several optical phenomena, it is represented by a sum of the elementary matrices defined above:

N=N₀+N₁+N₂+N₃+N₄+N₅+N₆+N₇. (20)

What is claimed is:

1. A method for characterizing a device under test, comprising:
providing an optical signal;
modulating a first portion of the optical signal to generate a first modulated signal;
applying the first modulated signal to a device under test (DUT) to output a test signal;
modulating a second portion of the optical signal to create a reference signal;
optically combining the test signal and the reference signal into a combined signal;
generating an electrical signal from the combined signal; and
processing the electrical signal to determine at least one optical parameter of the DUT, wherein processing the electrical signal includes demodulating the electrical signal.

2. A method as in claim 1, wherein demodulating the electrical signal includes determining the signal envelope of the electrical signal.

3. A method as in claim 2, wherein processing the electrical signal further includes performing a phase sensitive detection to extract the in-phase and quadrature components of the signal envelope.

4. A method as in claim 3, wherein the at least one optical parameter of the DUT is selected from the group consisting of: group delay (p₀), differential group delay, loss, polarization dependent loss, a 0° component of the differential group delay (p₁), a 45° component of the differential group delay (p₂), a circular component of the differential group delay (p₃), an absorption change per unit frequency (p₄), a frequency derivative of a 0° component of the polarization dependent loss (p₅), a frequency derivative of a 45° component of the polarization dependent loss (p₆), and a frequency derivative of a circular component of the polarization dependent loss (p₇).

5. A method as in claim 4, wherein modulating the first portion of the optical signal further includes:
creating optical sidebands for the first portion of the optical signal; and
controlling a polarization state of at least one pair of the optical sidebands.

6. A method as in claim 5, further comprising:
creating four different polarization states in the first portion of the optical signal to determine p₀, p₁, p₂, and p₃.

7. A method as in claim 1, wherein generating the electrical signal includes a square-law detection of the combined signal.

8. A method as in claim 1, wherein modulating the second portion of the optical signal further includes depolarizing the second portion of the optical signal.

9. A method as in claim 8, wherein demodulating the electrical signal includes determining the signal envelope of the electrical signal.

10. A method as in claim 9, wherein processing the electrical signal further includes performing a phase sensitive detection to extract the in-phase and quadrature components of the signal envelope.

11. A method as in claim 10, wherein the at least one optical parameter of the DUT is selected from the group consisting of: group delay (p₀), differential group delay, loss, polarization dependent loss, a 0° component of the differential group delay (p₁), a 45° component of the differential group delay (p₂), a circular component of the differential group delay (p₃), an absorption change per unit frequency (p₄), a frequency derivative of a 0° component of the polarization dependent loss (p₅), a frequency derivative of a 45° component of the polarization dependent loss (p₆), and a frequency derivative of a circular component of the polarization dependent loss (p₇).

12. A method as in claim 11, wherein determining at least one optical parameter of the DUT includes determining Stokes vector parameters describing a polarization state of the test signal.

13. A method as in claim 12, wherein modulating the first portion of the optical signal further includes:
creating optical sidebands for the first portion of the optical signal; and
controlling a polarization state of at least one pair of the optical sidebands.

14. A method as in claim 13, further comprising:
creating four different polarization states in the first portion of the optical signal to determine p₀, p₁, p₂, and p₃.

15. A method as in claim 8, wherein generating the electrical signal includes a square-law detection of the combined signal.

16. A system for characterizing a device under test (DUT), comprising:
an optical splitter that splits an optical signal into a first and second portion;
a first modulator that modulates the first portion of the optical signal and generates a first modulated signal;
a DUT interface for receiving the DUT and applying the first modulated signal to the DUT to output a test signal;
a second modulator that modulates the second portion of the optical signal and generates a reference signal;
a combiner that combines the test signal and the reference signal into a combined optical signal;
an optical sensor that converts the combined optical signal into an electrical signal; and
a processing unit that determines at least one optical parameter of the DUT, the processing unit further including a demodulator that demodulates the electrical signal.

17. A system as in claim 16, wherein the demodulator is an amplitude modulation (AM) demodulator.

18. A system as in claim 16, wherein the first modulator creates optical sidebands for the first portion of the optical signal and controls a polarization state of at least one pair of the optical sidebands.

19. A system as in claim 16, wherein the second modulator depolarizes the second portion of the optical signal.

20. A system as in claim 16, wherein the first and second modulators are lithium niobate polarization phase modulators.
